(19) United States
(12) Patent Application Publication
(10) Pub. No.: US 2010/0305728 A1
(43) Pub. Date: Dec. 2, 2010

(54) AUDIO DEVICE

(75) Inventor: Masaru Aiso, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 12/787,341

(22) Filed: May 25, 2010

(30) Foreign Application Priority Data
May 29, 2009 (JP) 2009-130042

(51) Int. Cl. G06F 17/00

(52) U.S. Cl. 700/94

(57) ABSTRACT

An audio device is composed of a digital processor and a communication interface. The digital signal processor performs a mixer process on a plurality of mix buses for mixing audio signals from a plurality of input channels and outputting the mixed signals to output channels and performs a signal process for controlling characteristics of audio signals. The digital signal processor performs the mixer process by means of a cross point process for controlling a level of an audio signal and adding the audio signal having the controlled level to a corresponding mix bus. The digital signal processor is provided with resources for enabling a plurality of cross point processes when an external audio device is connected to the audio device through the communication interface, the digital signal processor exchanges outputs of a plurality of mix buses with the external audio device and performs the mixer process on outputs of the plurality of mix buses received from the external audio device, as new mix buses, by means of cross point processes available among the plurality of cross point processes provided for the digital signal processor, thereby extending a number of mix buses.

### BACKGROUND OF THE INVENTION

1. Technical Field of the Invention

The present invention relates to audio devices having digital signal processors which can be connected through a communication path.

2. Description of the Related Art

A conventional digital mixer, which is an audio device used in concert halls or the like, adjusts the levels and frequency characteristics of audio signals output from a number of microphones and electric or electronic musical instruments, and mixes the adjusted audio signals and outputs the mixed signals to a power amplifier. An operator who operates the digital mixer adjusts the sound volume and tone of each audio signal of musical instrument sound or song to an optimal state, in which a played performance is heard optimally, by operating various types of panel controls provided on the digital mixer. The digital mixer includes buses for mixing audio signals from input channels and output channels for outputting the mixed audio signals. The input channels control the frequency characteristics, mixing levels, or the like of input audio signals and outputs the resulting signals to mix buses. Each mix buses mix input audio signals and output the resulting signal to a corresponding output channel. Signals output from the output channels are amplified and provided to speakers or the like, which then output the amplified sound signals.

The conventional digital mixer performs a variety of arithmetic processes on an input digital signal through a digital signal processor (DSP). The mixing processes performed by the DSP are mainly divided into two processes, one being an adjustment process such as equalization or compression which adjusts characteristics of audio signals, the other being a mixer process which controls levels of audio signals and mixes the level-controlled audio signals. The adjustment process varies depending on the device type or operation mode of the digital mixer, whereas the same mixer process is repeated, regardless of the device type or operation mode.

Japanese Patent Application Publication No. 2003-255945 describes a technology in which a musical sound generator that generates musical sounds of a plurality of channels, a DSP that performs an adjustment process, and a mixer unit that performs a mixer process are incorporated into one integrated circuit. In this technology, the mixer unit can select a signal which is input to each arithmetic operation channel that performs multiplication by a factor and can select a bus to which the signal is output. In addition, for each input channel, it is possible to arbitrarily specify the number of multiplications by factors and the number of mixings into the buses. For each mix bus, it is also possible to arbitrarily specify which channel signals are input to the mix bus and to arbitrarily specify an input channel through which each individual channel signal is input.

To cope with the case where one DSP does not provide sufficient arithmetic performance, each DSP includes an interface for connection to another DSP such that a plurality of DSPs can be connected through such interfaces to increase total arithmetic performance. Examples of such interfaces through which DSPs are connected include a serial I/O interface and an audio (A) bus I/O interface. However, when wirings are connected between DSPs so as to achieve desired transmission using serial I/O interfaces, there is a problem in that circuitry design is very difficult since the number of serial I/O ports is limited. On the other hand, when wirings are connected between DSPs so as to achieve desired transmission using audio I/O interfaces, using such highly general-purpose audio buses to extend the number of channels is very inefficient although circuitry design is not so difficult.

Japanese Patent Application Publication No. 2008-244898 describes a digital signal processing device for mixing which can be used for mixers of various specifications and which can simplify design of a circuit board for signal processing of a mixer which uses a plurality of DSPs and can facilitate design of a processing program that is executed by each of the DSPs. This digital signal processing device includes a plurality of signal processing integrated circuits that are connected in cascade. Each signal processing integrated circuit includes an adjustment processor that outputs digital audio signals processed based on a microprogram, a receiver that receives digital audio signals of a desired number of buses from a previous signal processing integrated circuit, a mixing processor that receives digital audio signals of a desired number of channels from the adjustment processor, mixes the signals respectively with the digital audio signals received by the receiver, and outputs the mixed signals corresponding to the desired number of buses, and a transmitter that transmits the signals corresponding to the desired number of buses to a next signal processing integrated circuit.

FIG. 9 illustrates a configuration in which conventional mixers 100A and 100B, each including a DSP and a cascade connection interface, are connected in cascade. As shown in FIG. 9, the mixers 100A and 100B are connected in cascade and exchange mixed signals of their mix buses to increase the number of apparent input channels for each of the mixers 100A and 100B. How the number of apparent input channels is increased is illustrated in FIG. 10. Specifically, FIG. 10 illustrates a schematic configuration of the mix buses of the mixers 100A and 100B. As shown in FIG. 10, the mixer 100A includes n input channels IN1A, IN2A, . . . , and INnA, m mix buses 1A, 2A, . . . , mA, and m output channels OutA. The mixer 100B also includes n input channels IN1B, IN2B, . . . , and INnB, m mix buses 1B, 2B, . . . , mB, and m output channels OutB. The mixers 100A and 100B constructed in this manner are connected in cascade to exchange mixed signals of the mix buses. Accordingly, mixed signals of the m mix buses 1A to mA of the mixer 100A are transmitted and added to the m mix buses 1B to mB of the mixer 100B, and vice versa mixed signals of the m mix buses 1B to mB of the mixer 100B are transmitted and added to the m mix buses 1A to mA of the mixer 100A.

That is, at a group of adder points SA of the mixer 100A, mixed signals of the m mix buses 1B to mB received from the mixer 100B are added to the m mix buses 1A to mA and mixed signals of the m mix buses 1A to mA are transmitted. In addition, at a group of adder points SB of the mixer 100B, mixed signals of the m mix buses 1A to mA received from the mixer 100A are added to the m mix buses 1B to mB and mixed signals of the m mix buses 1B to mB are transmitted. Arithmetic operations for multiplying an input channel signal by a level control factor and adding the resulting signal to a corresponding mix bus are performed at each cross point shown as a black dot mark “” other than the adder points SA and SB in FIG. 10.

Here, it has been suggested that the same arithmetic operations be performed at any cross point in the mixers 100A and 100B, and the amount of arithmetic operations corresponding to the number of n×m cross points in a DSP included in each of the mixers 100A and 100B, where n is the number of input channels and m is the number output channels, is semi-fixed. For example, when the number of cross points, which are resources of the DSP, is set to 576, the number of input and output channels can be set to 48×12, 24×24, or 96×6 since the amount of arithmetic operations is semi-fixed. In this case, it is possible to select a factor to be multiplied for each input channel, a signal which is input to each input channel, and a mix bus to which the input signal is output. It is also possible to set the number of cross points to 24×12 or 48×6 to leave a part of resources (some cross points).

However, when the number of cross points is set such that some cross points are left unused, there is a problem in that resources of the DSP are wasted, reducing efficiency of resources.

### SUMMARY OF THE INVENTION

Therefore, it is an object of the invention to provide an audio device including a digital signal processor which enables efficient use of resources.

To achieve the above object, an audio device of the invention comprises: a digital signal processor that performs a mixer process on a plurality of mix buses for mixing audio signals from a plurality of input channels and outputting the mixed signals to output channels and that performs a signal process for controlling characteristics of audio signals, wherein the digital signal processor performs the mixer process by means of a cross point process for controlling a level of an audio signal and adding the audio signal having the controlled level to a corresponding mix bus and wherein the digital signal processor is provided with resources for enabling a plurality of cross point processes; and a communication interface that enables connection to an external audio device, wherein, when the external audio device is connected to the communication interface, the digital signal processor exchanges outputs of a plurality of mix buses with the external audio device and performs the mixer process on outputs of the plurality of mix buses received from the external audio device, as new mix buses, by means of cross point processes available among the plurality of cross point processes provided for the digital signal processor, thereby extending a number of mix buses.

According to the invention, the digital signal processor performs the mixer process on outputs of the plurality of mix buses received from the external audio device, as new mix buses, using cross point processes that are not in use among the plurality of cross point processes provided for the digital signal processor, thereby logically or equivalently extending the number of mix buses. Accordingly, it is possible to efficiently use resources of the digital signal processor.

### BRIEF DESCRIPTION OF THE DRAWINGS

FIG. 1 is a block diagram illustrating a configuration of an audio device according to an embodiment of the invention.

FIG. 2 illustrates a state in which an audio device according to the invention is connected to another audio device according to the invention through a communication path.

FIG. 3 is a block diagram illustrating a DSP of an audio device according to the invention and a processing algorithm of an audio interface.

FIG. 4 illustrates allocation of resources of a DSP in an audio device according to the invention.

FIG. 5 illustrates a configuration in which an audio device according to the invention is connected to another audio device of the invention through a communication bus to extend the number of output channels.

FIG. 6 is an equivalent circuit block diagram of processes performed by the DSP in the audio device of the invention.

FIG. 7 is a circuit block diagram illustrating a configuration of a DSP in an audio device of the invention.

FIG. 8 is an operating timing chart of a mixer process performed by a DSP when audio devices of the invention are connected through a communication bus.

FIG. 9 illustrates a configuration in which conventional mixers are connected in cascade.

FIG. 10 illustrates a configuration in which conventional mixers are connected in cascade to extend the number of input channels.

### DETAILED DESCRIPTION OF THE INVENTION

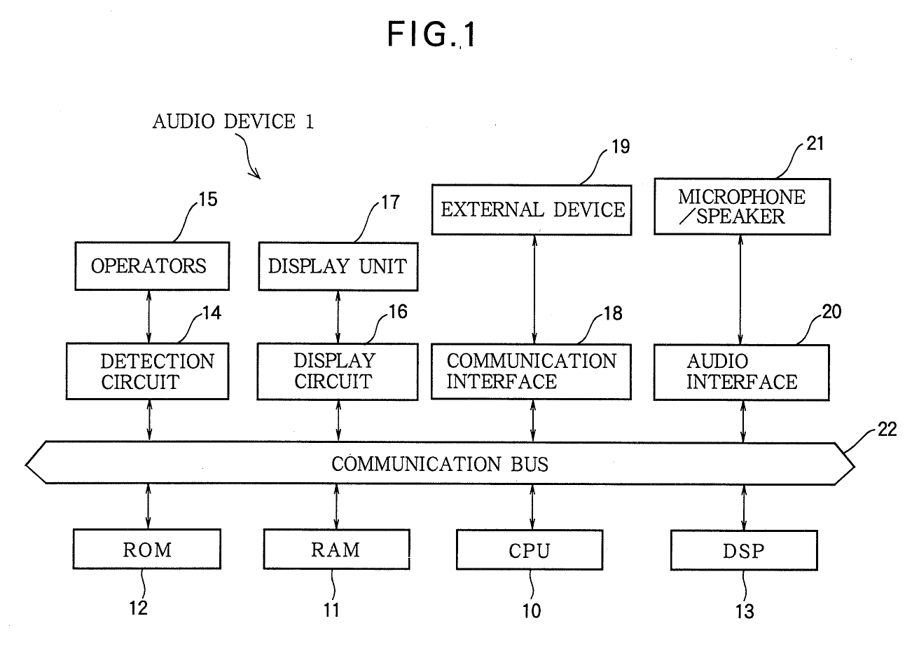

FIG. 1 is a block diagram illustrating a configuration of an audio device according to an embodiment of the invention.

In the audio device 1 shown in FIG. 1, a Central Processing Unit (CPU) 10 executes an Operating System (OS), which is a management program, and controls the overall operation of the audio device 1 through the OS. The audio device 1 includes a Read Only Memory (ROM) 12 which is a computer readable storage medium and which stores an operation program such as a mixing control program that is executed by the CPU 10 and a Random Access Memory (RAM) 11 which stores a variety of data and work area data of the CPU 10. The CPU 10 executes the mixing control program to cause a Digital Signal Processor (DSP) 13 to perform an audio signal process on a plurality of input audio signals to mix the input audio signals. A rewritable ROM such as a flash memory may be used as the ROM 12 to allow rewriting of the operation program and to facilitate version upgrade of the operation program. Under control of the CPU 10, the DSP 13 mixes the input audio signals after adjusting volume levels, frequency characteristics, and the like of the input audio signals based on corresponding parameters and performs a digital signal process on the mixed signals to control acoustic characteristics thereof such as volume, pan, and effects based on corresponding parameters.

A detection circuit 14 scans controls or operators 15 such as faders, knobs, and switches mounted on a panel of the audio device 1 to detect operations performed on the operators 15. The detection circuit 14 can change values of the parameters that are used for the audio signal process based on detected operation signals. A display circuit 16 causes a display unit 17, which includes a display panel such as a liquid crystal display panel, to display a variety of mixing-related windows. A communication interface (I/F) 18 is an interface for connection to an external device 19 to perform communication with the external device 19. The communication interface 18 may be an interface for a network based on, for example, Ethernet (registered trademark) and the external device 19 may be an audio device or the like having the same configuration as the audio device 1. An audio interface 20 is a network interface for exchanging audio signals with a microphone/speaker 21 that outputs or receives audio signals. The DSP 13 performs the above-described digital signal process on an audio signal from the microphone 21 or the like input through the audio interface 20. A processed audio signal such as a mixed audio signal is output through the speaker 21, which is directed toward audience seats or the like, via the audio interface 20. Each of these components exchanges data with each other through a communication bus 22.

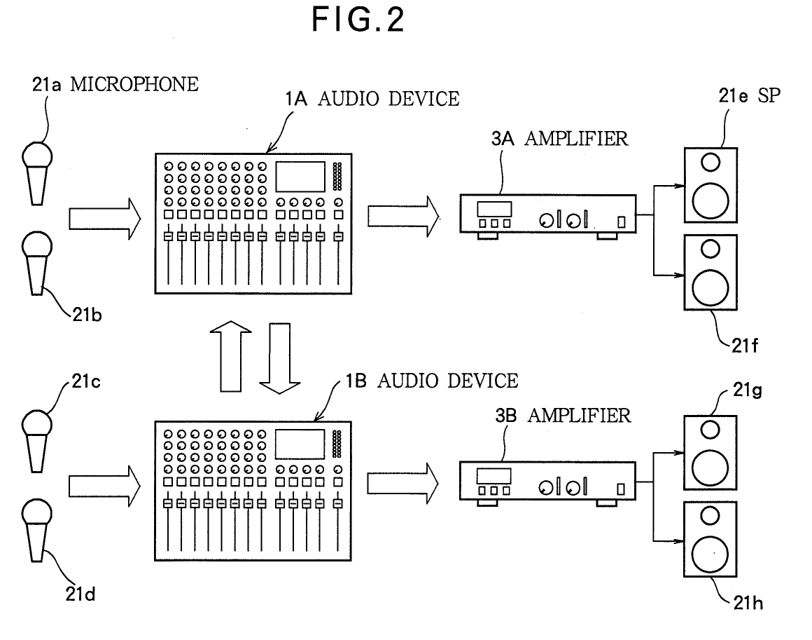

FIG. 2 illustrates a configuration in which audio devices 1A and 1B according to the invention, each being constructed as shown in FIG. 1, are connected through a communication interface 18.

In the configuration shown in FIG. 2, audio signals from a signal source (not shown) and audio signals from microphones 21a and 21b installed on a stage or the like are input to the audio device 1A through an audio interface 20 of the audio device 1A and a digital signal process is performed on input channel signals through a DSP 13 included in the audio device 1A. In the digital signal process, the DSP 13 adjusts acoustic characteristics of the input channel signals and controls levels of the input channel signals based on parameters and mixes the resulting signals and then outputs the mixed audio signals. The mixed audio signals are emitted through a plurality of speakers 21e and 21f installed in a conference room or the like after being amplified through an amplifier 3A. Similarly, audio signals from a signal source (not shown) and audio signals from microphones 21c and 21d installed on a stage or the like are input to the audio device 1B through an audio interface 20 of the audio device 1B. A DSP 13 in the audio device 1B adjusts acoustic characteristics of the input channel signals and controls levels of the input channel signals based on parameters and mixes the adjusted signals and then outputs the mixed audio signals. The mixed audio signals are emitted through a plurality of speakers 21g and 21h installed in a conference room or the like after being amplified through an amplifier 3B.

The audio devices 1A and 1B are connected through respective communication interfaces 18 such that output channel signals mixed by the audio device 1A are transmitted to the audio device 1B through the communication interface 18 of the audio device 1A and the transmitted signals are received by the audio device 1B through the communication interface 18 of the audio device 1B. The audio device 1B performs mixer processes for mixing channel signals input to the audio device 1B with the output channel signals received by the audio device 1B to equivalently extend the number of output channels as described below. In addition, output channel signals mixed by the audio device 1B are transmitted to the audio device 1A through the communication interface 18 of the audio device 1B and the transmitted signals are received by the audio device 1A through the communication interface 18 of the audio device 1A. The audio device 1A performs the same mixer processes as in the audio device 1B to equivalently extend the number of output channels.

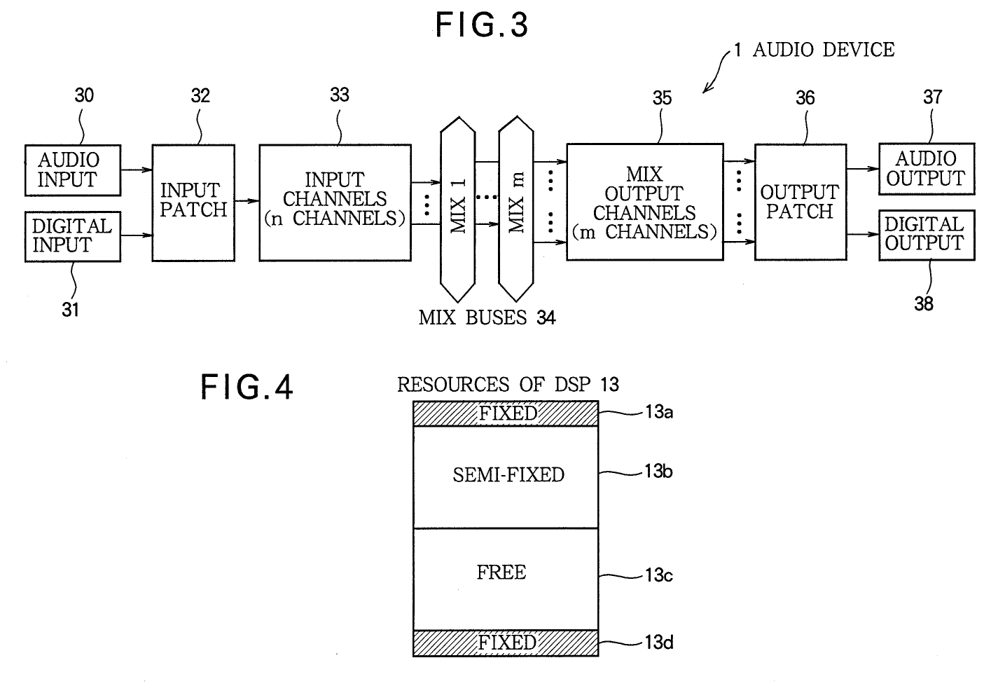

FIG. 3 illustrates a processing algorithm of the DSP 13 and the audio interface 20 in each of the audio devices 1A and 1B.

As shown in FIG. 3, analog signals input to analog input ports (Analog input) 30 are acquired by the audio device 1 through the audio interface 20 and converted into digital signals and the digital signals are input to an input patch 32. On the other hand, digital signals input to digital input ports (Digital input) 31 are directly input to the input patch 32. In the input patch 32, one of the input ports, through which signals are input, can be selectively patched (i.e., connected) to each input channel of a multiple input channel portion 33, which includes n input channels, and a signal from an input port patched to each input channel in the input patch 32 is provided to the input channel.

Each input channel of the input channel portion 33 includes an attenuator, an equalizer, a compressor or gate, a fader, and a send adjuster that adjusts the level of a signal output to each mix bus 34. Each input channel controls the level of an input audio signal and outputs the resulting signal to the mix buses 34. Digital signals of n channels output from the input channel portion 33 are selectively output to one or more of the m mix buses 34. Each of the m mix buses 34 mixes one or more digital signals, which are selectively input from one or more of the n input channels. The m mix buses 34 then output the mixed signals of all m channels to a mix output channel portion 35. M mixed signals of the m output channels can be obtained in this manner.

Each output channel of a mix output channel portion 35 includes an attenuator, an equalizer, a compressor, and a fader and performs frequency balancing and level adjustment and controls the level of output to an output patch 36. In the output patch 36, one of the mixed signals of m channels from the mix output channel portion 35 can be selectively patched (i.e., connected) to each output channel of an analog output port unit (Analog output) 37 or a digital output port unit (Digital output) 38, and a signal from an output channel patched to each output port in the output patch 36 is provided to the output port.

Digital output signals provided to the analog output port unit 37 including a plurality of analog output ports are converted into analog output signals and are then output through the analog output ports. The analog output signals output from the analog output port unit 37 are amplified through the amplifiers 3A and 3B and the amplified audio signals are output through a plurality of speakers 21e to 21h. In addition, the analog output signals are provided to an in-ear monitor mounted in an ear of the performer or are reproduced through a stage monitor speaker installed near the performer. Digital audio signals output from the digital output port unit 38 including a plurality of digital output ports may be provided to a recorder, an externally connected DAT, or the like so that the signals are digitally recorded.

FIG. 4 illustrates allocation of resources for processes performed by the DSP 13 included in each of the audio devices 1A and 1B. Fixed resources 13a and 13d are inherent resources for use by the DSP 13 and semi-fixed resources 13b are resources provided for a cross point process in the mixer process described later which performs level control on input channel signals and adds the resulting signal to a desired mix bus and then outputs the added signal. The purpose of setting the resources 13b to be semi-fixed is to change the number of output channels which are output from the mix buses while changing the number of input channels which are input to the mix buses. When the amount of resources of the semi-fixed resources 13b is L, it is possible to set the number of input and output channels to n×m when L≧n×m, where n is the number of input channels and m is the number of output channels. Free resources 13c are resources used for an audio signal process that performs compression, equalization, effects processing, and the like on audio signals in the mixer process.

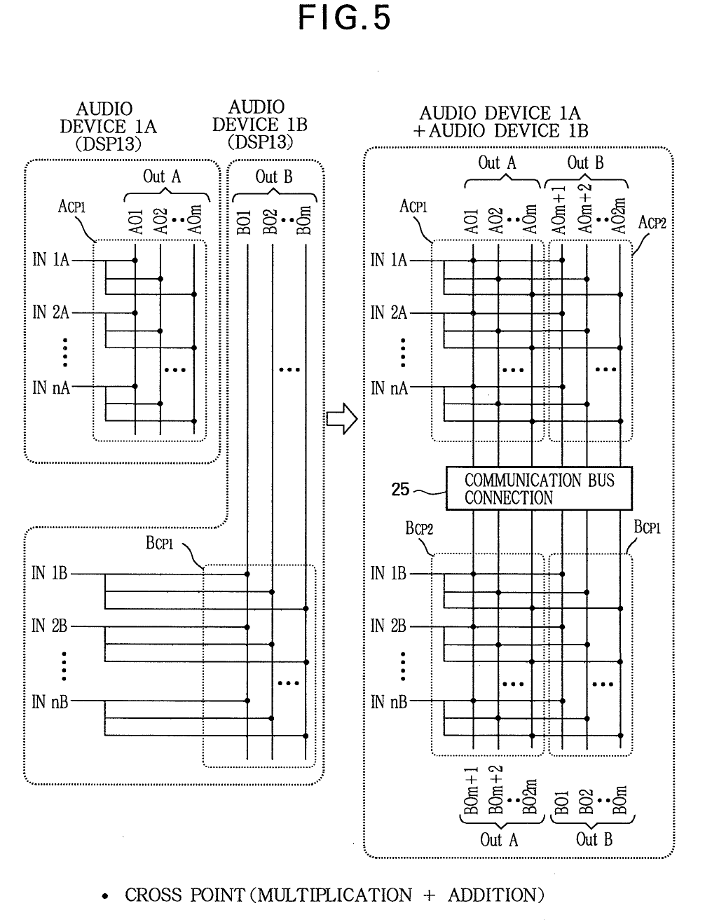

A lower left half portion of FIG. 5 illustrates the cross point process in the mixer process performed by the DSP 13 in each of the audio devices 1A and 1B. The audio device 1A includes n input channels IN1A, IN2A, . . . , INnA, and m output channels AO1, AO2, . . . , AOm which are output from mix buses. A cross point process is performed at each cross point shown as “” defined at each intersection in a matrix of the input channels IN1A to INnA and the output channels AO1 to AOm. For example, at the cross point between the input channel IN1A and the output channel AO1, an input channel signal from the input channel IN1A is multiplied by a factor to control the level of the input channel signal and the multiplied signal is added to a signal of the output channel AO1 and the added signal is then output to the output channel AO1. The same cross point process is performed at other cross points. When the amount of resources of the semi-fixed resources 13b is L, an amount of resources corresponding to, for example, L/2 are used in cross point processes performed in a range A_{CP1}, and thus only one half of the amount of resources L are used in n×m cross point processes in the range A_{CP1} in this example.

Similarly, the audio device 1B includes n input channels IN1B, IN2B, INnB, and m output channels BO1, BO2, . . . , BOm which are output from mix buses. A cross point process is performed at each cross point shown as “” defined at each intersection in a matrix of the input channels IN1B to INnB and the output channels BO1 to BOm. For example, at the cross point between the input channel IN1B and the output channel BO1, an input channel signal from the input channel IN1B is multiplied by a given factor to control the level of the input channel signal and the multiplied signal is added to a signal of the output channel BO1 and the added signal is then output to the output channel BO1. The same cross point process is performed at other cross points. When the amount of resources of the semi-fixed resources 13b is L, an amount of resources corresponding to, for example, L/2 are used in cross point processes performed in a range B_{CP1}, and thus only one half of the amount of resources L are used in n×m cross point processes in the range B_{CP1} in this example.

FIG. 5 illustrates a configuration in which the audio device 1A is connected to the audio device 1B through the communication interfaces 18 of the audio devices 1A and 1B to extend the number of output channels. The number of output channels is extended in the following manner. When the audio device 1A and the audio device 1B are connected through the communication interfaces 18 of the audio devices 1A and 1B, a combination of the audio devices 1A and 1B is equivalently configured as shown in a right half portion of FIG. 5. That is, output channel signals from the output channels AO1 to AOm of the audio device 1A are transmitted to the audio device 1B through a communication bus connection 25 included the communication interfaces 18. In this case, each of the audio devices 1A and 1B is constructed as described above. In the audio device 1B, a cross point process is performed at each cross point shown as “” at each intersection in a matrix of the input channels IN1B to INnB and m output channels BOm+1, BOm+2, . . . BO2m corresponding to respective output channel signals from the output channels AO1 to AOm as shown in FIG. 5. In a range of B_{CP2}, cross point processes are performed using the other half of the semi-fixed resources 13b which have not been used for the range B_{CP1}. Cross point processes at cross points shown as “” at intersections in a matrix of the input channels IN1B to INnB and the output channels BO1 to BOm in the range B_{CP1} are performed using the half of the semi-fixed resources 13b that have been used as described above. Accordingly, the audio device 1B outputs both the m channels OutA and the m channels OutB, thereby extending the number of output channels to 2m.

In the configuration of the output channels where the number of output channels has been extended to 2m equivalently or logically or virtually, the m mix buses 34 corresponding to the output channels AO1 to AOm in the audio device 1A operate so as to be equivalently connected respectively to the m mix buses 34 corresponding to the output channels BOm+1 to BO2m in the audio device 1B. The m mix buses 34 corresponding to the output channels AOm+1 to AOm2 also operate so as to be equivalently connected respectively to the m mix buses 34 corresponding to the output channels BO1 to BOm in the audio device 1B.

Similarly, when the audio device 1A is connected to the audio device 1B through the communication interfaces 18 of the audio devices 1A and 1B, output channel signals from the output channels BO1 to BOm of the audio device 1B are transmitted to the audio device 1A through the communication bus connection 25 including the communication interfaces 18. In the audio device 1A, a cross point process is performed at each cross point shown as “” defined at each intersection in a matrix of the input channels IN1A to INnA and m output channels AOm+1, AOm+2, . . . , AO2m corresponding to respective output channel signals from the output channels BO1 to BOm as shown in FIG. 5. In a range of A_{CP2}, cross point processes are performed using the other half of the semi-fixed resources 13b which have not been used for a range of A_{cp1}. Cross point processes at cross points shown as “” at intersections in a matrix of the input channels IN1A to INnA and the output channels AO1 to AOm in the range A_{CP1} are performed using the half of the semi-fixed resources 13b that have been used as described above. Accordingly, the audio device 1A outputs both the m channels OutA and the m channels OutB, thereby extending the number of output channels to 2m.

As described above, the communication interface 18 connects the external audio device 1B having a plurality of mix buses (corresponding to output channels BO1 to BOm) to the audio device 1A such that the plurality of mix buses (corresponding to output channels BO1 to BOm) of the external audio device 1B are introduced or logically extended into the audio device 1A as the new mix buses AOm+1 to AO2m.

The digital signal processor DSP13 of the audio device 1A applies each cross point process to each cross point defined between each input channel IN and each mix bus (corresponding to each output channel AO). In case that the external audio device 1B is connected to the audio device 1A, the digital signal processor 13 of the audio device 1A allocates a part A_{cp1} of the plurality of cross point processes to cross points defined between the input channels IN1A-INnA and the plurality of mix buses (corresponding to output channels AO1 to AOm) originally provided in the digital signal processor 13 and allocates another part A_{cp2} of the plurality of cross point processes to cross points defined between the input channels IN1A-INnA and the plurality of mix buses (corresponding to output channels AO1+m to AO2m) introduced into the digital signal processor 13.

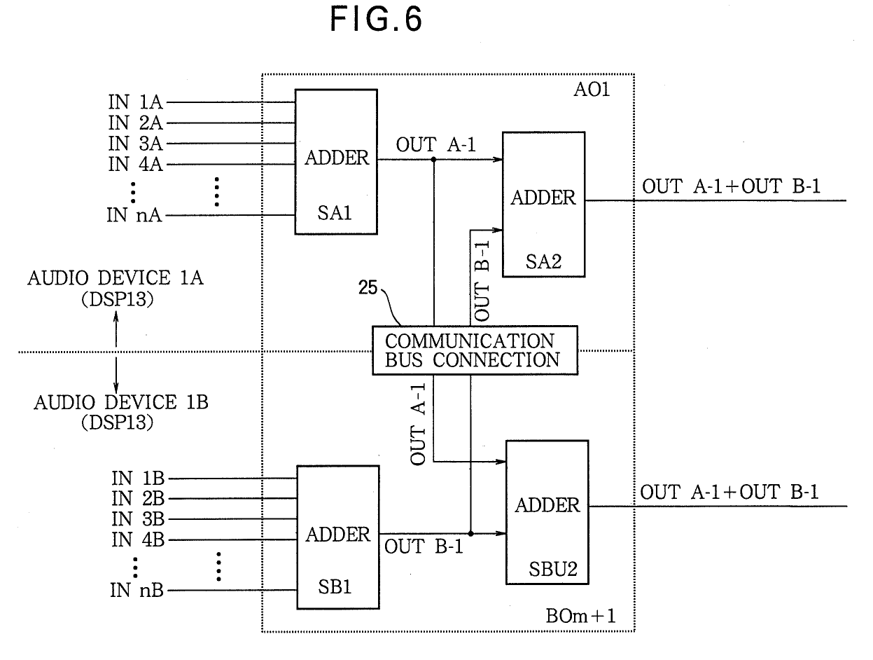

While each cross point process is implemented by the DSP 13 executing the microprogram, an equivalent circuit block diagram of the cross point process is illustrated in FIG. 6. However, the configuration of the output channel AO1 in the audio device 1A and the output channel BOm+1 in the audio device 1B is illustrated as a representative example in FIG. 6. An adder SA1 and an adder SA2 shown in FIG. 6 correspond to processes performed in the mix bus 34 in association with the output channel AO1, and an adder SB1 and an adder SB2 correspond to processes performed in the mix bus 34 in association with the output channel BOm+1. The adder SA1 adds input channel signals selected from those of the input channels IN1A to INnA in the audio device 1A after multiplying each input channel signal by a level control factor. An added signal OUTA-1 of the adder SA1 is transmitted to the audio device 1B through the communication bus connection 25 and is also output to the adder SA2. The adder SB1 adds input channel signals selected from those of the input channels IN1B to INnB in the audio device 1B after multiplying each input channel signal by a level control factor. An added signal OUTB-1 of the adder SB1 is transmitted to the audio device 1A through the communication bus connection 25 and is also output to the adder SB2.

The adder SA2 adds the added signal OUTA-1 and the added signal OUTB-1 transmitted from the audio device 1B and outputs the resulting signal. Accordingly, the output channel AO1 outputs an output channel signal of OUTA-1+OUTB-1. The adder SB2 adds the added signal OUTB-1 and the added signal OUTA-1 transmitted from the audio device 1A and outputs the resulting signal. Accordingly, the output channel BOm+1 outputs an output channel signal of OUTA-1+OUTB-1. Since the output channels AO1 and BOm+1 output the same output channel signal and the same is true for other output channels, the m output channels OutA and the m output channels OutB of the audio device 1A and the m output channels OutA and the m output channels OutB of the audio device 1B output the same output channel signals.

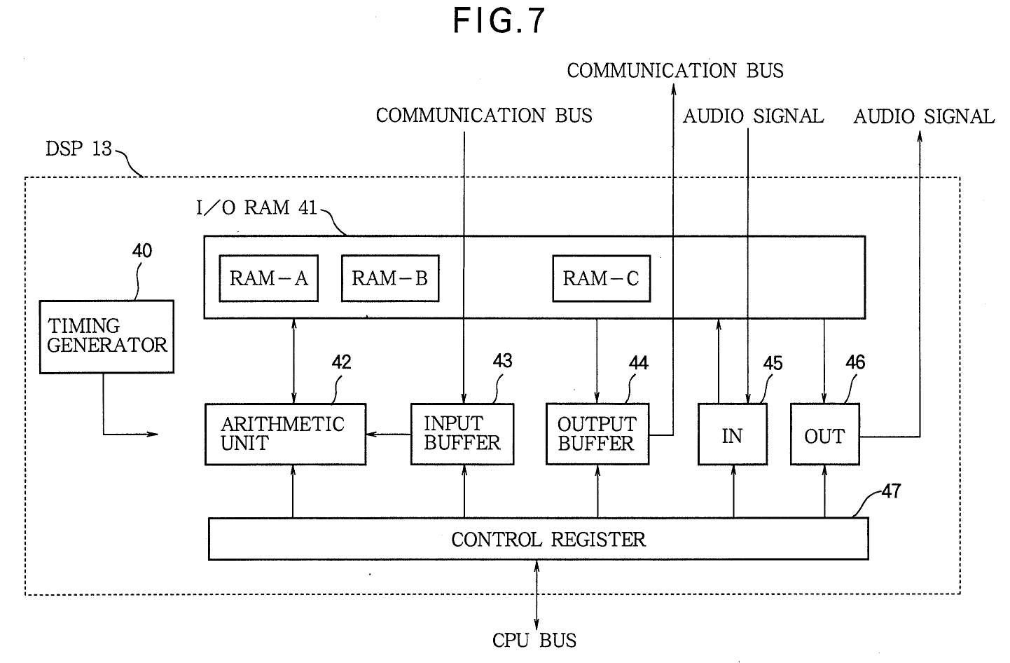

FIG. 7 is a block circuit diagram illustrating a configuration of the DSP 13 that performs the above processes.

Each block of the DSP 13 shown in FIG. 7 is described as follows. A timing generator 40 provides a timing signal required for operation of each block, and each block operates at a timing according to the timing signal provided from the timing generator 40. The arithmetic unit 42 performs digital signal processing for mixing including an adjustment process which adjusts characteristics of audio signals and a mixer process that controls the levels of the audio signals and mixes the level-controlled signals. A microprogram for processes that the arithmetic unit 42 performs in each sampling period, factor data used for the processes, or the like are set in a control register 47. Mixer processes performed by the arithmetic unit 42 include a mixer process A performed by the adder SA1 in FIG. 6 and a mixer process B performed by the adder SA2 in FIG. 6. An I/O RAM 41 includes a RAM-C used for the adjustment process, a RAM-A used for the mixer process A, and a RAM-B used for the mixer process B. The arithmetic unit 42 performs the adjustment process on a signal read from the RAM-C by repeatedly executing the microprogram while reading factor data from the control register 47 and then stores the resulting signal in the RAM-C.

To perform the mixer processes A and B, the arithmetic unit 42 performs the cross point process described above by repeatedly executing a product-sum operation microprogram. In the mixer process A, factor data in the control register 47 is used, a signal to be mixed is read from the RAM-C, another signal to be mixed is read from the RAM-A, and a resulting signal of the mixer process A corresponding to the output of the adder SA1 is written to the RAM-A. In the mixer process B, a signal to be mixed is read from the RAM-A, another signal to be mixed is read from an input buffer 43, and a resulting signal of the mixer process B corresponding to the output of the adder SA2 is written to the RAM-B. The input buffer 43 temporarily stores a plurality of signals sequentially transmitted from an audio device externally connected through the communication bus connection 25. Signals of all output channels, which are results of the mixer process A, are read from the RAM-A. An output buffer 44 temporarily stores signals of all output channels read from the RAM-A and outputs the signals to an externally connected audio device at a predetermined timing.

An input interface circuit (IN) 45 is a circuit which receives input audio signals. The input audio signals are then written to a predetermined region of the I/O RAM 41. The input patch 32 is implemented in the input interface circuit 45. That is, which input signal is written to which address of the I/O RAM 41 corresponds to which input port in the input patch 32 is connected to which input channel. An output interface circuit (OUT) 46 is a circuit which reads and outputs output channel data from the RAM-B of the I/O RAM 41. The output patch 36 is implemented in the output interface circuit 46. That is, which address signal of the I/O RAM 41 is output to which output line corresponds to which output channel in the output patch 36 is connected to which output port.

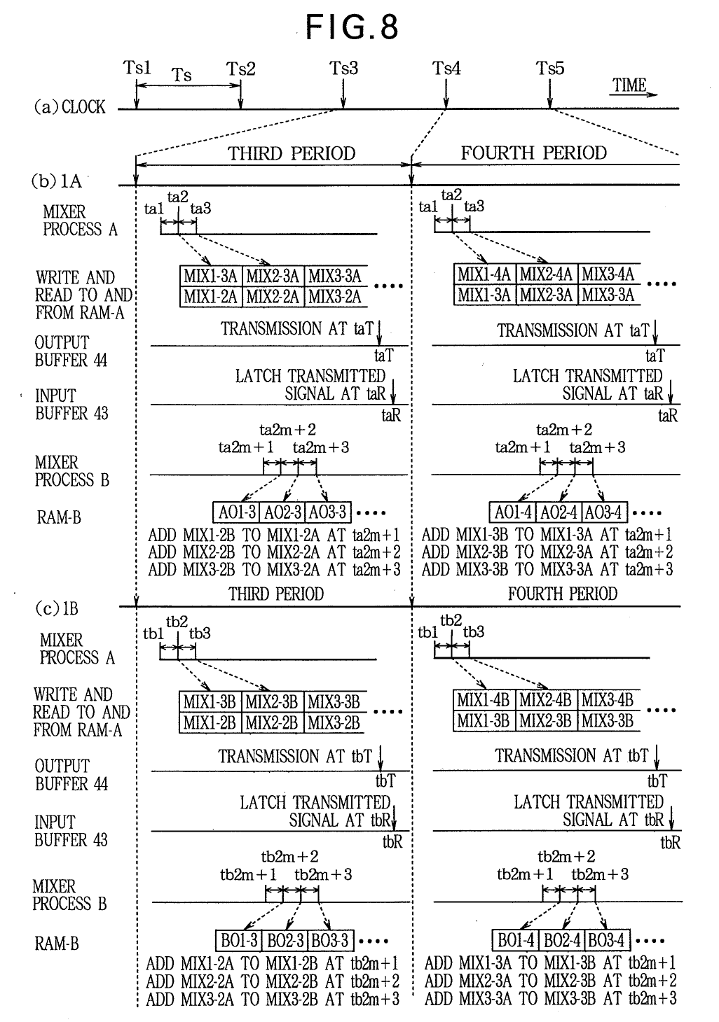

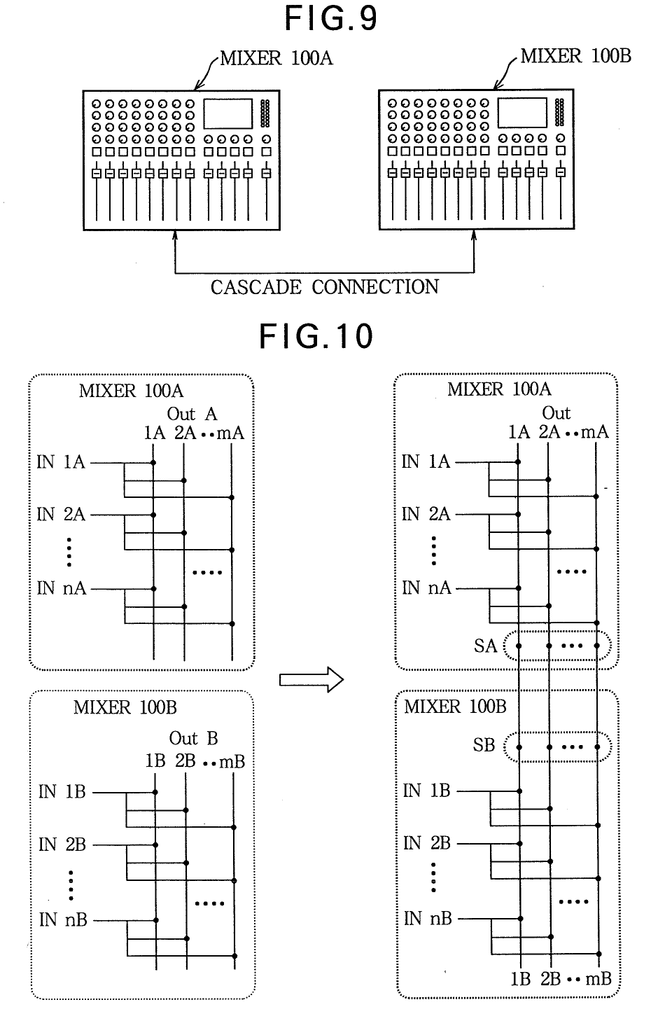

FIG. 8 illustrates an operating timing chart of a mixer process including cross point processes performed by the DSP 13 when the audio device 1A and the audio device 1B are connected through the communication bus connection 25.

A horizontal axis in FIG. 8 represents time and each clock shown in part (a) of FIG. 8 is one sampling period Ts. For example, the sampling frequency is 48 kHz and one sampling period Ts is 20.8 μ seconds. In the adjustment process or the mixer process, for example, processes of 3072 steps are performed per sampling period Ts based on an operating clock of 166 MHz and margins may be placed before and after these processes. A part (b) of FIG. 8 illustrates an operating timing of the audio device 1A and a part (c) of FIG. 8 illustrates an operating timing of the audio device 1B. The RAM-A in the I/O RAM 41 includes a double buffer and each buffer of the RAM-A is switched between a write mode and a read mode in each sampling period.

A third period of Ts3-Ts4 and a fourth period of Ts4-Ts5 are described as follows. In the third period, the arithmetic unit 42 in the audio device 1A performs a cross point process for multiplying an input channel signal of the input channel IN1A read from the RAM-C by a factor read from the control register 47 and adding the multiplied input channel signal to a signal of a mix bus corresponding to the output channel AO1 read from the RAM-A and then performs a similar cross point process for multiplying an input channel signal of an input channel IN2A by a factor read from the control register 47 and adding the multiplied input channel signal to the mix bus signal to which the signal of the input channel IN1A has been added. The arithmetic unit 42 repeats these cross point processes until a cross point process of an input channel signal of the input channel INnA is performed and writes a third sampled signal MIX1-3A of the output channel AO1, which is a result of such cross point processes, to the RAM-A at a timing ta2. Next, the arithmetic unit 42 performs processes on the output channel AO2 in the following manner. That is, the arithmetic unit 42 performs a cross point process for multiplying an input channel signal of the input channel IN1A read from the RAM-C by a factor read from the control register 47 and adding the multiplied input channel signal to a signal of a mix bus corresponding to the output channel AO2 read from the RAM-A and then performs a similar cross point process for multiplying an input channel signal of an input channel IN2A by a factor read from the control register 47 and adding the multiplied input channel signal to the mix bus signal to which the signal of the input channel IN1A has been added. The arithmetic unit 42 repeats these cross point processes until a cross point process of an input channel signal of the input channel INnA is performed and writes a third sampled signal MIX2-3A of the output channel AO2, which is a result of such cross point processes, to the RAM-A at a timing ta3.

The arithmetic unit 42 repeats the mixer process A until a mixer process of the mix bus corresponding to the output channel AO2m is performed. Accordingly, 2m third sampled signals MIX1-3A, MIX2-3A, MIX3-3A, . . . of the output channels AO1 to AO2m are stored in the RAM-A of the audio device 1A until a timing ta2m+1. These 2m third sampled signals are written to the output buffer 44 at a predetermined timing after the signals are generated and are transmitted to the audio device 1B through the communication bus connection 25 at a timing taT in the marginal period before the third period is terminated.

In addition, 2m second sampled signals MIX1-2B, MIX2-2B, MIX3-2B, . . . that the audio device 1B generates in the second period, which precedes the third period, are transmitted from the audio device 1B to the audio device 1A and are latched to the input buffer 43 of the audio device 1A at a timing taR in a marginal period before the second period (not shown) is terminated. The audio device 1A starts a mixer process B at a timing ta2m+1 at which the mixer process A is terminated and adds the second sampled signal MIX1-2B read from the input buffer 43 to the second sampled signal MIX1-2A read from the RAM-A and writes the third output sampled signal AO1-3 of the output channel AO1 as the resulting signal to the RAM-B at timing ta2m+3. The audio device 1A then adds the second sampled signal MIX2-2B read from the input buffer 43 to the second sampled signal MIX2-2A read from the RAM-A and writes the third output sampled signal AO2-3 of the output channel AO2 as the resulting signal to the RAM-B at timing ta2m+3. In addition, the audio device 1A adds the second sampled signal MIX3-2B read from the input buffer 43 to the second sampled signal MIX3-2A read from the RAM-A and writes the third output sampled signal AO3-3 of the output channel AO3 as the resulting signal to the RAM-B at timing ta2m+4. The audio device 1A repeats such a mixer process B until the third sampled signal AO2m−3 of the output channel AO2m is generated. Accordingly, 2m third input channel signals AO1-1, AO2-3, AO3-3, . . . of the output channels AO1 to AO2m are stored in the RAM-B of the audio device 1A until the third period is terminated.

Similar to the audio device 1A, the audio device 1B operates in the following manner. In the third period, the arithmetic unit 42 in the audio device 1B performs a cross point process for multiplying an input channel signal of the input channel IN1B read from the RAM-C by a factor read from the control register 47 and adding the multiplied input channel signal to a signal of a mix bus corresponding to the output channel BO1 read from the RAM-A and then performs a similar cross point process for multiplying an input channel signal of an input channel IN2B by a factor read from the control register 47 and adding the multiplied input channel signal to the mix bus signal to which the signal of the input channel IN1B has been added. The arithmetic unit 42 repeats these cross point processes until a cross point process of an input channel signal of the input channel INnB is performed and writes a third sampled signal MIX1-3B of the output channel BO1, which is a result of such cross point processes, to the RAM-A at a timing tb2. Next, the arithmetic unit 42 performs a cross point process for multiplying an input channel signal of the input channel IN1B read from the RAM-C by a factor read from the control register 47 and adding the multiplied input channel signal to a signal of a mix bus corresponding to the output channel BO2 read from the RAM-A and then performs a similar cross point process for multiplying an input channel signal of an input channel IN2B by a factor read from the control register 47 and adding the multiplied input channel signal to the mix bus signal to which the signal of the input channel IN1B has been added. The arithmetic unit 42 repeats these cross point processes until a cross point process of an input channel signal of the input channel INnB is performed and writes a third sampled signal MIX2-3B of the output channel BO2, which is a result of such cross point processes, to the RAM-A at a timing tb3.

The arithmetic unit 42 repeats the mixer process A until a mixer process of the mix bus corresponding to the output channel BO2m is performed. Accordingly, 2m third sampled signals MIX1-3B, MIX2-3B, MIX3-3B, . . . of the output channels BO1 to BO2m are stored in the RAM-B of the audio device 1B until a timing tb2m+1. These 2m third sampled signals are written to the output buffer 44 at a predetermined timing after the signals are generated and are transmitted to the audio device 1A through the communication bus connection 25 at a timing tbT in the marginal period before the third period is terminated.

In addition, 2m second sampled signals MIX1-2A, MIX2-2A, MIX3-2A, . . . that the audio device 1A generates in the second period, which precedes the third period, are transmitted from the audio device 1A to the audio device 1B and are latched to the input buffer 43 of the audio device 1B at a timing tbR in a marginal period before the second period (not shown) is terminated. The audio device 1B starts a mixer process B at a timing tb2m+1 at which the mixer process A is terminated and adds the second sampled signal MIX1-2A read from the input buffer 43 to the second sampled signal MIX1-2B read from the RAM-A and writes the third output sampled signal BO1-3 of the output channel BO1 as the resulting signal to the RAM-B at timing tb2m+3. The audio device 1B then adds the second sampled signal MIX2-2A read from the input buffer 43 to the second sampled signal MIX2-2B read from the RAM-A and writes the third output sampled signal BO2-3 of the output channel BO2 as the resulting signal to the RAM-B at timing tb2m+3. In addition, the audio device 1B adds the second sampled signal MIX3-2A read from the input buffer 43 to the second sampled signal MIX3-2B read from the RAM-A and writes the third output sampled signal BO3-3 of the output channel BO3 as the resulting signal to the RAM-B at timing tb2m+4. The audio device 1B repeats such a mixer process B until the third sampled signal BO2m−3 of the output channel BO2m is generated. Accordingly, 2m third input channel signals BO1-1, BO2-3, BO3-3, . . . of the output channels BO1 to BO2m are stored in the RAM-B of the audio device 1B until the third period is terminated.

In the fourth period shown in FIG. 8, the audio device 1A operates in the same manner as in the third period. That is, in the audio device 1A, 2m fourth sampled signals MIX1-4A, MIX2-4A, MIX3-4A, . . . of the output channels AO1 to AO2m are generated and stored in the RAM-A. Then, the 2m fourth sampled signals are written to the output buffer 44 at a predetermined timing after the fourth sampled signals are generated and are then transmitted to the audio device 1B through the communication bus connection 25 at a timing taT in a marginal period before the fourth period is terminated. In addition, 2m fourth output sampled signals AO1-3, AO2-3, AO3-3, . . . of the output channels AO1 to AO2m generated using the 2m third output sampled signals transmitted from the audio device 1B before the third period is terminated are stored in the RAM-B of the audio device 1A.

Similarly, in the fourth period, the audio device 1B operates as follows. That is, in the audio device 1B, 2m fourth sampled signals MIX1-4B, MIX2-4B, MIX3-4B, . . . of the output channels BO1 to BO2m are generated and stored in the RAM-A. Then, the 2m fourth sampled signals are written to the output buffer 44 at a predetermined timing after the fourth sampled signals are generated and are then transmitted to the audio device 1A through the communication bus connection 25 at a timing tbT in a marginal period before the fourth period is terminated. In addition, 2m fourth output sampled signals BO1-3, BO2-3, BO3-3, . . . of the output channels BO1 to BO2m generated using the 2m third output sampled signals transmitted from the audio device 1A before the third period is terminated are stored in the RAM-B of the audio device 1B.

In each of the audio device 1A and the audio device 1B, 2m output sampled signals stored in the RAM-B at timing immediately before each period not shown in FIG. 8 are output to a corresponding one of the amplifiers 3A and 3B through the output interface circuit 46.

The audio device of the invention has been described above with reference to an example in which only half of the semi-fixed resources are used among the resources of the DSP in each of the audio devices 1A and 1B. In this example, it is possible to equivalently extend the number of output channels twice by using the remaining half of the semi-fixed resources when the audio devices 1A and 1B have been connected for communication. In this case, it is possible to equivalently extend the number of output channels twice only when half or less of the semi-fixed resources are in use. It is also possible to equivalently extend the number of output channels when more than half of the semi-fixed resources are in use. For example, when ¾ of the semi-fixed resources are used among the resources of the DSP in each of the audio devices 1A and 1B, it is possible to equivalently extend the number of output channels by 4/3 by using the remaining semi-fixed resources when the audio devices 1A and 1B have been connected for communication.

What is claimed is:

1. An audio device comprising:
a digital signal processor that performs a mixer process on a plurality of mix buses for mixing audio signals from a plurality of input channels and outputting the mixed signals to output channels and that performs a signal process for controlling characteristics of audio signals, wherein the digital signal processor performs the mixer process by means of a cross point process for controlling a level of an audio signal and adding the audio signal having the controlled level to a corresponding mix bus and wherein the digital signal processor is provided with resources for enabling a plurality of cross point processes; and
a communication interface that enables connection to an external audio device,
wherein, when the external audio device is connected to the communication interface, the digital signal processor exchanges outputs of a plurality of mix buses with the external audio device and performs the mixer process on outputs of the plurality of mix buses received from the external audio device, as new mix buses, by means of cross point processes available among the plurality of cross point processes provided for the digital signal processor, thereby extending a number of mix buses.

2. The audio device according to claim 1, wherein the communication interface connects the external audio device having a plurality of mix buses to the audio device such that the plurality of mix buses of the external audio device are introduced into the audio device as the new mix buses.

3. The audio device according to claim 2, wherein the digital signal processor applies each cross point process to each cross point defined between each input channel and each mix bus, and wherein the digital signal processor allocates a part of the plurality of cross point processes to cross points defined between the input channels and the plurality of mix buses originally provided in the digital signal processor and allocates another part of the plurality of cross point processes to cross points defined between the input channels and the plurality of new mix buses introduced into the digital signal processor.
